(19) United States
(12) Patent Application Publication
(10) Pub. No.: US 2010/0029426 A1
(43) Pub. Date: Feb. 4, 2010

(54) MECHANICAL CONNECTION FOR TOOTHED BELTS

(75) Inventor: Antonio PONS SANCHEZ, Sant Just Desvern (ES)

Correspondence Address: YOUNG & THOMPSON, 209 Madison Street, Suite 500, Alexandria, VA, 22314, US

(73) Assignee: TPT MECTROL, S.L., Sant Just Desvern (ES)

(21) Appl. No.: 12/428,072

(22) Filed: Apr. 22, 2009

(30) Foreign Application Priority Data
Aug. 1, 2008 (ES) 200801707

(51) Int. Cl. F16G 13/06; B23P 19/04

(52) U.S. Cl. 474/206; 29/240

(57) ABSTRACT

Mechanical connection for toothed belts, of the type that are used to be able to open and close a toothed belt that is equipped with reinforcing cables, essentially characterized by the fact that the connection is composed of a preferably metal hinge (1) that pivots around a shaft (2) and that at its ends has edges (3) to which the ends of the reinforcing cables (4) are attached, whereby the hinge (1) is integrated into the body of the toothed belt (6), such that the shaft (2) of the hinge coincides with the center of a tooth (7), which has a line cutting along the point where the hinge (8) and the attachment edges (3) of the cables (4) connect to the adjacent teeth (9 and 10).

### TECHNICAL FIELD

The subject of this invention, as set forth in the preamble to this specification, refers to a mechanical connection for toothed belts of the type that incorporate internal reinforcing wires, whereby said connection makes it possible to open and close the belt as needed.

### BACKGROUND TO THE INVENTION

In general, a toothed belt is composed of a strip that is made of a thermoplastic elastomer into which a structure that imparts tensile strength is packed, whereby said structure is generally a set of parallel wires or cables that are arranged across the entire strip.

These belts are commonly used to transfer motion between two parallel shafts, and, because of their metal reinforcements, they are able to withstand high stresses, which is why they are common components in many kinds of machinery; such belts have to be replaced periodically since they are subjected to stresses that cause them to wear out quickly.

This maintenance operation can be very complicated since these belts form closed loops that almost always make it necessary to disassemble the shafts, tensioners, guides, crowns, and many other component parts of the machine in which they are installed simply in order to insert said belts (whereas, in order to remove a damaged tooth belt, it is only necessary to cut it). This fact is so significant that, in order to replace a worn or damaged belt, which costs very little compared to the cost of the machine overall, the machine has to remain out of service for several hours between its disassembly and reassembly and, in some cases, the recalibration of the system; for this reason, the operating costs of maintenance turn out to be extraordinarily high.

To solve this problem, toothed belts have been developed that are equipped with mechanisms that make it possible to open and close them, thereby making it considerably simpler to install them in the machine since they are mounted in the open state onto the shafts on which they have to operate and are then closed. It is thus necessary to disassemble few, if any, parts.

The problem with these toothed belts that have means of opening and closing is that, in the closed position, the loop remains effectively closed but the metal reinforcements are left open, and therefore the closure zone is supported against tensile stress only by the body of the belt, which is thus a weak point.

### DESCRIPTION OF THE INVENTION

In order to overcome the above-mentioned drawbacks, the novel toothed-belt connection has been designed, by means of which the reinforcing cables also remain closed along with the body of the belt, thus ensuring that its tensile strength and endurance tensile strength are exactly the same as those of a conventional toothed belt.

Specifically, the new mechanical connection is composed of a metal hinge that pivots around a shaft and that at its ends has small edges for attaching the ends of the reinforcing cables. This hinge is integrated into the body of the toothed belt and is covered with the polymer so that when the shaft, which simultaneously acts as a bolt, is inserted or removed, the hinge can be opened and closed.

The attachment of the cables to the edges is preferably done mechanically by means of headless screws, although any other kind of attachment that guarantees acceptable durability could be used, for example, attachment by welding.

The insertion of the bolt-shaft is preferably done by plugging it into the recess in the hinge or by threading.

Functionally, the shaft of the hinge has to coincide with the center of a tooth on the belt, and the cable attachment edges have to coincide with the teeth that are contiguous to said center. Thus, the flat zone that extends from the shaft of the hinge to its ends, where the attachment edges are located, always occupies the valley space between teeth.

Each cell on the edge houses between one and no more than three cables so that they will not be subjected to excessive bending stresses that could affect their operation.

### DESCRIPTION OF THE DRAWINGS

In order to illustrate what we have described up to this point, attached to this specification and being an integral part thereof is a set of drawings that show, in a simplified and diagrammatic manner, an example embodiment, which is intended solely for illustrative purposes and is in no way limiting, of the characteristics of the novel invention.

FIG. 1 shows a detail of a toothed belt that is equipped with the claimed connection.

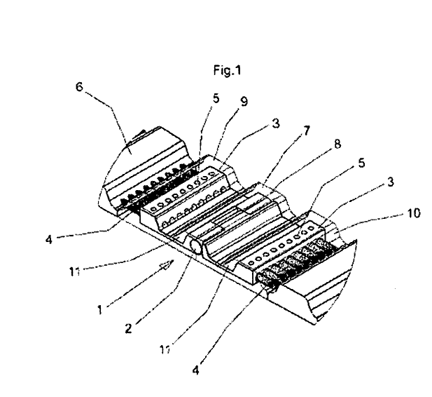

### DESCRIPTION OF AN EMBODIMENT

The new mechanical connection is composed of a metal hinge (1) that pivots around a shaft (2) and that at its ends has small edges (3) for attaching the ends of the reinforcing cables (4) by means of headless screws (5).

This hinge (1) is integrated into the body of the toothed belt (6), such that the shaft (2) of the hinge coincides with the center of a tooth (7), which has a line that cuts along the place where the hinge (8) and the attachment edges (3) of the cables (4) connects to the contiguous teeth (9 and 10).

The flat zone (11) that extends from the zone of the shaft (2) of the hinge (1) to the point where the attachment edges (3) are located occupies the valley space (12) between the above-mentioned teeth.

The object of the invention is independent of the materials that are used in the manufacture of the various parts that make it up, as well as of the shapes, dimensions, and accessories that it may have, whereby they can be replaced by others that are technically equivalent, provided that they do not affect the essence of the invention or fall beyond the scope defined by the Claims.

To put the concept outlined above into concrete terms, below is the Claims section, which summarizes the novel aspects that are to be claimed:

1. Mechanical connection for toothed belts, of the type that are used to be able to open and close a toothed belt that is equipped with reinforcing cables, essentially characterized by the fact that said connection is composed of a preferably metal hinge (1) that pivots around a shaft (2) and that at its ends has edges (3) to which the ends of the reinforcing cables (4) are attached, whereby the hinge (1) is integrated into the body of the toothed belt (6), such that the shaft (2) of the hinge coincides with the center of a tooth (7), which has a line cutting along the point where the hinge (8) and the attachment edges (3) of the cables (4) connect to the adjacent teeth (9 and 10).

2. Mechanical connection for toothed belts according to claim 1, wherein the attachment of the cables (4) to the edge (3) is preferably done mechanically, by means of headless screws (5).

3. Mechanical connection for toothed belts according to claim 1, wherein the attachment of the cables (4) to the edge (3) is done by welding.

4. Mechanical connection for toothed belts according to claim 2, wherein the attachment of the shaft (2) to the hinge (1) is done by plugging the latter into the recess in the hinge.

5. Mechanical connection for toothed belts according to claim 1, wherein the attachment of the shaft (2) to the hinge (1) is accomplished by screwing the latter into the recess in the hinge.

6. Mechanical connection for toothed belts according to claim 1, wherein each cell of the edge (3) houses between one and no more than three reinforcing cables (4).

7. Mechanical connection for toothed belts according to claim 3, wherein the attachment of the shaft (2) to the hinge (1) is done by plugging the latter into the recess in the hinge.

8. Mechanical connection for toothed belts according to claim 2, wherein the attachment of the shaft (2) to the hinge (1) is accomplished by screwing the latter into the recess in the hinge.

9. Mechanical connection for toothed belts according to claim 3, wherein the attachment of the shaft (2) to the hinge (1) is accomplished by screwing the latter into the recess in the hinge.

10. Mechanical connection for toothed belts according to claim 2, wherein each cell of the edge (3) houses between one and no more than three reinforcing cables (4).

11. Mechanical connection for toothed belts according to claim 3, wherein each cell of the edge (3) houses between one and no more than three reinforcing cables (4).

12. Mechanical connection for toothed belts according to claim 4, wherein each cell of the edge (3) houses between one and no more than three reinforcing cables (4).

13. Mechanical connection for toothed belts according to claim 5, wherein each cell of the edge (3) houses between one and no more than three reinforcing cables (4).

14. Mechanical connection for toothed belts according to claim 7, wherein each cell of the edge (3) houses between one and no more than three reinforcing cables (4).

15. Mechanical connection for toothed belts according to claim 6, wherein each cell of the edge (3) houses between one and no more than three reinforcing cables (4).

16. Mechanical connection for toothed belts according to claim 9, wherein each cell of the edge (3) houses between one and no more than three reinforcing cables (4).
